(19) United States
(12) Patent Application Publication
(10) Pub. No.: US 2022/0314372 A1
(43) Pub. Date: Oct. 6, 2022

(54) SYSTEM AND METHOD FOR MAKING AN ENHANCED CAST IRON WORKPIECE HAVING INCREASED LUBRICANT RETENTION

(71) Applicant: GM Global Technology Operations LLC, Detroit, MI (US)

(72) Inventors: Benjamin E. Slattery, Tecumseh (CA); Daniel T. Berry, Novi, MI (US); Daniel L. Baker, Goodrich, MI (US); Frank D. Risko, Clarkston, MI (US)

(21) Appl. No.: 17/217,483

(22) Filed: Mar. 30, 2021

(51) Int. Cl. B23K 26/40

(52) U.S. Cl. CPC B23K 26/40; B23K 2103/06

(57) ABSTRACT

A method of making an enhanced cast iron workpiece having increased oil retention is provided. The method comprises providing a laser tool arranged to emit a laser to perform carbon burn-off from a cast iron workpiece. The cast iron workpiece comprises cast iron and having a first surface with carbon microstructures thereon. The method further comprises selectively laser burning-off carbon microstructures from the first surface of the workpiece to form a pattern on the first surface. The pattern has separate pockets by the laser burn-off of carbon microstructures on the first surface. Each separate pocket is separate from and free of fluid communication with any other pocket relative to the first surface to provide enhanced lubricant retention in each pocket on the first surface. The method further comprises heating the workpiece to between about 200° C. and about 400° C. to temper the first surface and cooling the workpiece to ambient temperature.

### INTRODUCTION

The present disclosure relates to workpieces having lubricant retention and more particularly systems and methods of making enhanced cast iron workpieces having increased oil retention.

Many traditional cast iron cylinder bores and other workpieces rely on a honing process. The honing process provides a plateau cross-hatched hone surface for oil retention and friction reduction of an opposing body, e.g., a piston ring, against the workpiece. Due to the nature of cross-hatching, oil retention pathways are often interconnected which can be tribologically undesirable.

### SUMMARY

Thus, while current approaches achieve their intended purpose, there is a need for a new and improved system and method for making an enhanced cast iron workpiece having increased lubricant retention.

According to one aspect of the present invention, a method of making an enhanced cast iron workpiece having increased oil retention is disclosed. The method comprises providing a laser tool arranged to emit a laser to perform carbon burn-off from a cast iron workpiece. The cast iron workpiece comprising cast iron and has a first surface with carbon microstructures thereon. The method further comprises cleaning the workpiece to remove contamination thereon.

Moreover, the method comprises selectively laser burning-off carbon microstructures from the first surface of the workpiece to form a pattern on the first surface. The pattern has separate pockets by the laser burn-off of carbon microstructures on the first surface. Each separate pocket is separate from and free of fluid communication with any other pocket relative to the first surface, creating enhanced lubricant retention in each pocket on the first surface. The method further comprises heating the workpiece to between about 200° C. and about 400° C. to temper the first surface. Furthermore, the method comprises cooling the workpiece to ambient temperature, defining the enhanced cast iron workpiece having increased lubricant retention.

In one example of this aspect, the method further comprises preheating the workpiece to between about 200° C. and about 400° C. to decrease risk of cracking. In another example, the method further comprises preheating the workpiece to between about 250° C. and about 350° C. to decrease risk of cracking. In yet another example of this aspect, the method further comprises preheating the workpiece to about 350° C. to decrease risk of cracking.

In an example of this aspect, the step of heating comprises heating the workpiece to between about 200° C. and about 400° C. to temper the first surface when the hardness of the cast iron workpiece is greater than about 600 Hv (Vickers hardness scale) after the step of selectively laser burning-off carbon microstructure. In another example, the method further comprises heating the workpiece to between about 250° C. and about 350° C. to temper the first surface. In yet another example of this aspect, the method further comprises heating the workpiece to between about 350° C. to temper the first surface.

In another example of this aspect, the step of laser burning-off includes a laser output of between about 4000 W and about 9000 W. In yet another example, the laser output is about 4800 W.

In still another example of this aspect, the carbon microstructures are graphite.

In another aspect of the present disclosure, a system for making an enhanced cast iron workpiece having increased oil retention is disclosed. In one embodiment, the system comprises a cast iron workpiece comprising cast iron and having a first surface with carbon microstructures thereon. The system further comprises a laser tool arranged to emit a laser on the cast iron workpiece to selectively laser burning-off carbon microstructures from the first surface of the cast iron workpiece forming a pattern on the first surface. In this embodiment, the pattern has separate pockets formed on the first surface by the laser. Moreover, each separate pocket is separate from and free of fluid communication with any other pocket relative to the first surface, creating enhanced lubricant retention in each pocket of the first surface.

In this embodiment, the system further comprises a power source configured to power the laser tool and a controller configured to control the power to the laser tool to burn-off carbon microstructures from the first surface of the cast iron workpiece.

In another embodiment of this aspect, the system further comprises a first furnace for preheating the workpiece to between about 200° C. and about 400° C. to decrease risk of cracking. In yet another embodiment, the system comprises a first furnace for preheating the workpiece to between about 250° C. and about 350° C. to decrease risk of cracking. In still another embodiment, the system further comprises a first furnace for preheating the workpiece to about 350° C. to decrease risk of cracking.

In one embodiment of this aspect, the system further comprises a second furnace for heating the workpiece to between about 200° C. and about 400° C. to temper the first surface when the hardness of the cast iron workpiece is greater than about 600 Hv after the step of selectively laser burning-off carbon microstructure. In another embodiment, the system further comprises a second furnace for heating the workpiece to between about 250° C. and about 350° C. to temper the first surface when the hardness of the cast iron workpiece is greater than about 600 Hv after the step of selectively laser burning-off carbon microstructure. In still another embodiment, the system further comprises a second furnace for heating the workpiece to about 350° C. to temper the first surface when the hardness of the cast iron workpiece is greater than about 600 Hv after the step of selectively laser burning-off carbon microstructure.

In an embodiment of this aspect, the laser tool is arranged to emit a laser having an output of between about 4000 W and about 9000 W. In another embodiment, the laser output is about 4800 W.

In another aspect of the present disclosure, a method of making an enhanced cast iron workpiece having increased oil retention is provided. The method comprises providing a laser tool arranged to emit a laser to perform carbon burn-off from a cast iron workpiece. The cast iron workpiece comprising cast iron and having a first surface with carbon microstructures thereon. The method further comprises cleaning the workpiece to remove contamination thereon.

Moreover, the method further comprises selectively laser burning-off carbon microstructures from the first surface of the workpiece to form a pattern on the first surface. The pattern has separate pockets by the laser burn-off of carbon microstructures on the first surface. Each separate pocket is separate from and free of fluid communication with any other pocket relative to the first surface, creating enhanced lubricant retention in each pocket on the first surface.

In this aspect, the method further comprises heating the workpiece to between about 200° C. and about 400° C. to temper the first surface when the hardness of the cast iron workpiece is greater than about 600 Hv after the step of selectively laser burning-off carbon microstructure. Furthermore, the method comprises cooling the workpiece to ambient temperature, defining the enhanced cast iron workpiece having increased lubricant retention.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system for making an enhanced cast iron workpiece having increased oil retention in accordance with one embodiment of the present disclosure.

FIG. 2 is a conceptual perspective view of an enhanced workpiece having increased oil retention implemented by the system in FIG. 1.

FIG. 3 is a conceptual cross-sectional side view of the enhanced workpiece.

FIG. 4 is a flowchart of one method of making an enhanced cast iron workpiece having increased oil retention implemented by the system of FIG. 1 in accordance with one example of the present disclosure.

FIG. 5 is a flowchart of another method of making an enhanced cast iron workpiece having increased oil retention implemented by the system of FIG. 1.

### DETAILED DESCRIPTION

The following description is merely exemplary in nature and is not intended to limit the present disclosure, application, or uses.

The present disclosure provides systems and methods for making an enhanced cast iron workpiece having increased oil retention. A laser burns off and vaporizes carbon microstructures from a first surface of a workpiece. The burn-off and vaporizing of such carbon microstructures leave voids, pockets or pressurizing chambers on the first surface of the workpiece. Lubricant may be more effectively retained in such voids for enhanced lubrication thereon during tribological performance of the workpiece. When an opposing body moves across the first surface during operation, pressure in the voids containing lubricant builds up and supports hydrodynamic lubrication regime. The voids prevent (or lessens) migration of lubricant therein. As a result, the voids provide surface texture on the first surface to support lubricant retention between the first surface and the opposing body.

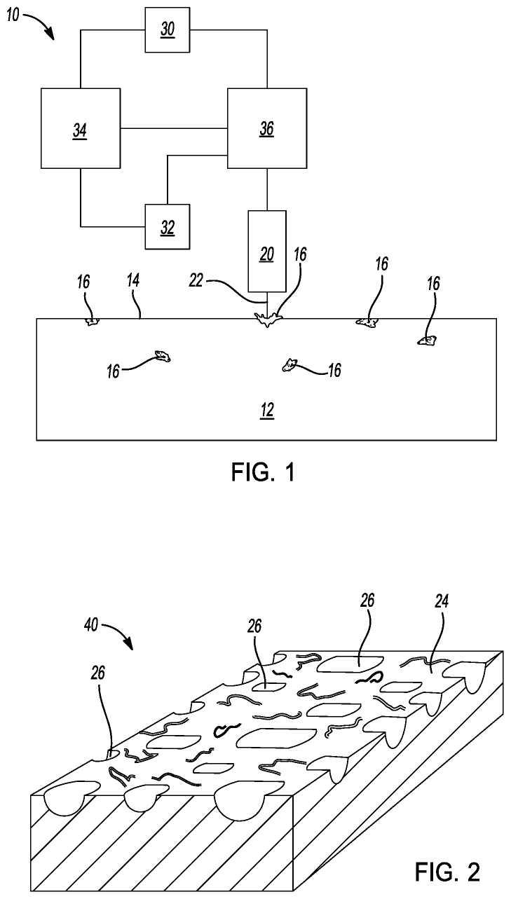

In accordance with one embodiment of the present disclosure, FIG. 1 illustrates a system 10 for making an enhanced cast iron workpiece having increased oil retention. As shown, the system 10 comprises a cast iron workpiece 12 comprising cast iron. The cast iron workpiece 12 may be a crankshaft, a cylinder having a bore, or any other suitable workpiece having carbon microstructures 16 formed thereon. Moreover, the cast iron workpiece 12 has a first surface 14 with carbon microstructures 16 disposed thereon and within a subsurface thereof.

In this embodiment, the system 10 further comprises a laser tool 20 arranged to emit a laser 22 on the cast iron workpiece 12 to selectively laser burning-off carbon microstructures 16 from the first surface 14 of the cast iron workpiece 12. In one embodiment, the laser tool 20 is arranged to emit a laser 22 having an output of between about 4000 W and about 9000 W. In another embodiment, the laser tool 20 is arranged to emit a laser 22 having an output of preferably about 4800 W.

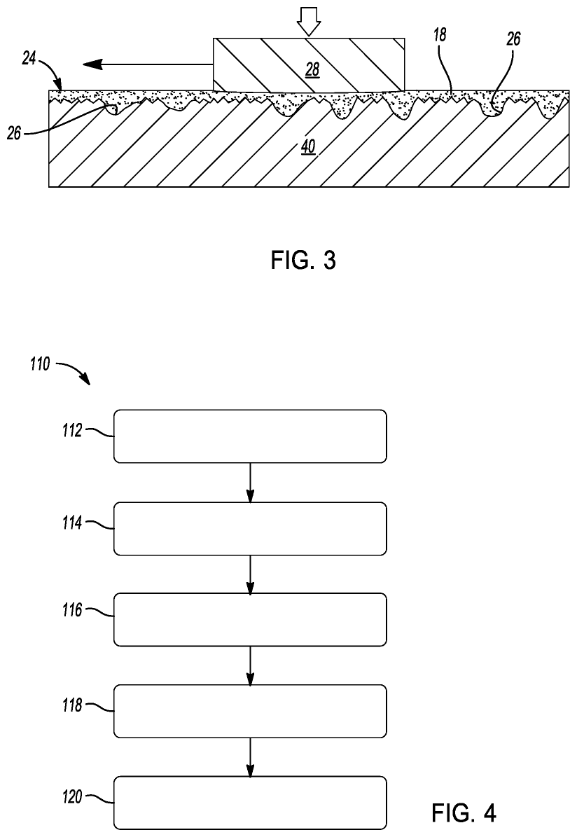

Preferably, the laser 22 burns and vaporizes carbon microstructures 16, such as graphite, from the first surface 14 to form a customized area or pattern 24 on the first surface 14 and subsurface of the workpiece 12 as shown in FIGS. 2 and 3. In this embodiment, the pattern 24 has separate lubrication pockets, voids, or micro-pressure chambers 26 formed on the first surface 14 by the laser 22 where the carbon microstructures 16 were located and removed. Such pockets 26 on the first surface 14 may be used for lubricant or oil retention during tribilogical performance when an opposed body (e.g., a piston ring) moves across the first surface 14 of the workpiece 12 (e.g. a cylinder having a bore) during operation.

Moreover, the location of such lubrication pockets 26 can be customized to regions of the workpiece 12, e.g., a cylinder bore, requiring more oil retention (e.g., top dead center and bottom dead center) and can also be distributed as a pattern. Upon laser burn-off and vaporization of the carbon microstructures 16, such patterns will not modify the entirety of the first surface 14 but rather modify only selected areas where carbon microstructures 16 were located thereon. Thus, a majority of the first surface 14 will serve as solid lubricants in the event of extreme tribological occurrence during operation of the workpiece 12.

Moreover, each separate pocket is separate from and free of fluid communication with any other pocket relative to the first surface 14, creating enhanced lubricant retention in each pocket of the first surface 14 during tribological performance of the workpiece 12. Moreover, each pocket 26 is free of any oil retention pathways and any interconnection with or between other pockets 26. That is, each pocket does not include a pathway interconnected with any other pocket 26.

Thus, each lubrication pocket 26 is separate from any other lubrication pocket such that when an opposing body 28 moves across the first surface 14 during operation, lubricant migration is prevented (or lessened) between pockets 26, allowing lubricant 18 (e.g., oil) to be retained therein to facilitate improved oil retention. The enhanced lubricant retention defines a micro-pressurized chamber when an opposing body 28 (e.g. a piston ring) movably slides across the first surface 14 of the workpiece 12 (e.g., a cylinder bore).

Laser graphite burn-off may be performed at select locations or patterns 24 within an inner diameter of a cylinder bore workpiece as an example. Laser graphite burn-off can either be performed on a loose liner using a stationary laser head and a rotating liner fixture. Alternatively, laser burn-off can be performed via a rotating laser head and stationary liner/bore such as in a case of iron liners precast into an engine block or monolithic/linerless cast iron engine blocks. Laser burn-off may be performed on other suitable cast iron workpieces without departing from the scope or spirit of the present disclosure.

It is to be noted that that geometry (thickness) of the workpiece or target material, the desired oil retention characteristics (e.g., volume, depth, density, or quantity), and desired hardness will determine laser characteristics and parameters (e.g., spot size, intensity, energy, dithering, frequency). An example of laser parameters performed on a cast iron workpiece is provided below.

To lessen or prevent mass quenching after graphite burn-off, the workpiece 12 may be preheated prior to laser burn-off. Thus, the system 10 may further comprise a first furnace 30. That is, prior to laser burn-off, the workpiece 12 may be placed in the first furnace 30 for preheating to between about 200° C. and about 400° C. to decrease risk of cracking after laser burn-off. Preferably, the workpiece 12 may be placed in the first furnace 30 for preheating to between about 250° C. and about 350° C., and more preferably to about 350° C. to decrease risk of cracking after laser burn-off. Moreover, preheating may improve throughput by reducing the laser exposure time required for graphite burn-off. Preheat may also reduce the risk of thin liners cracking during the laser graphite burn-off process.

After laser burn-off, tempering may be performed on the workpiece 12 to lessen case hardening. Tempering may be performed on the workpiece 12 when the hardness of the cast iron workpiece 12 is greater than about 600 Hv (Vickers hardness scale) after selectively laser burning-off carbon microstructures 16. Thus, as shown in FIG. 1, the system 10 may further comprise a second furnace 32 for heating the workpiece 12 to between about 200° C. and about 400° C. to temper the first surface 14 when the hardness of the cast iron workpiece 12 is greater than about 600 Hv after selectively laser burning-off carbon microstructures 16. In another embodiment, the second furnace 32 may heat the workpiece 12 to between about 250° C. and about 350° C., more preferably to about 300° C., to temper the first surface 14.

As shown in FIG. 1, the system 10 further comprises a power source 34 configured to power the laser tool 20, the first furnace 30, the second furnace 32, and a controller 36. In this embodiment, the controller 36 is configured to control the operation and power to the laser tool 20, the first furnace 30 and the second furnace 32. Furthermore, finish machining and/or honing of liners to a desired surface finish (e.g., mirror finish, cross-hatched finish) may be performed.

In accordance with one example of the present disclosure, FIG. 4 depicts a method 110 of making an enhanced cast iron workpiece having increased oil retention. In this example, the method 110 is implemented by the system 10 described above and shown in FIG. 1. However, any other suitable system may be used without departing from the spirit or scope of the present disclosure.

As shown, the method 110 comprises in box 112 providing a laser tool 20 arranged to emit a laser 22 to perform carbon burn-off from a cast iron workpiece 12. The cast iron workpiece 12 comprises cast iron and has a first surface 14 with carbon microstructures 16 thereon and within a subsurface thereof. In this example, the cast iron workpiece 12 may be a crankshaft, a cylinder having a bore, or any other suitable workpiece having carbon microstructures 16 formed thereon. In one embodiment, the laser tool 20 is arranged to emit a laser 22 having an output of between about 4000 W and about 9000 W. In another embodiment, the laser tool 20 is arranged to emit a laser 22 having an output of preferably about 4800 W.

The method 110 further comprises in box 114 cleaning workpiece 12 to remove contamination thereon. The step of cleaning the workpiece 12 may be accomplished by an industrial washer and dried by air or by furnace. In one example, the industrial washer may be a water-based cleaner using relatively low and high pressure cleaning as known in the art.

Moreover, the method 110 comprises in box 116 selectively laser burning-off carbon microstructures 16 from the first surface 14 of the workpiece 12 to form a pattern 24 on the first surface 14. Preferably, the laser burns and vaporizes carbon microstructures 16, such as graphite, from the first surface 14 to form a customized area or pattern 24 on the first surface 14 and subsurface of the workpiece 12. In this embodiment, the pattern 24 has separate lubrication pockets, voids, or micro-pressure chambers 26 formed on the first surface 14 by the laser 22 where the carbon microstructures 16 were located and removed. Such pockets 26 on the first surface 14 may be used for lubricant or oil retention during tribilogical performance when an opposed body moves across the first surface 14 during operation.

Moreover, the location of such lubrication pockets 26 can be customized to regions of the workpiece 12, e.g., a cylinder bore, requiring more oil retention (e.g., top dead center and bottom dead center) and can also be distributed as a pattern. Upon laser burn-off and vaporization of the carbon microstructures 16, such patterns will not modify the entirety of the first surface 14 but rather modify only selected areas where carbon microstructures 16 were located thereon. Thus, a majority of the first surface 14 will serve as solid lubricants in the event of extreme tribological occurrence during operation of the workpiece 12.

Moreover, each separate pocket is separate from and free of fluid communication with any other pocket relative to the first surface 14, creating enhanced lubricant retention in each pocket of the first surface 14 during tribological performance of the workpiece 12. Moreover, each pocket 26 is free of any oil retention pathways and any interconnection with or between other pockets 26. That is, each pocket does not include a pathway interconnected with any other pocket.

Thus, each lubrication pocket is separate from any other lubrication pocket such that when an opposing body 28 moves across the first surface 14 during operation, lubricant migration is prevented (or lessened) between pockets 26, allowing lubricant 18 (e.g., oil) to be retained therein to facilitate improved oil retention. The enhanced lubricant retention defines a micro-pressurized chamber when an opposing body 28, e.g. a piston ring, movably slides across the first surface 14.

As shown in FIG. 4, the method 110 further comprises in box 118 heating the workpiece 12 to between about 200° C. and about 400° C. to temper the first surface 14. After laser burn-off, tempering is preferably be performed on the workpiece 12 to lessen case hardening. Tempering may be performed on the workpiece 12 when the hardness of the cast iron workpiece 12 is greater than about 600 Hv (Vickers hardness scale) after selectively laser burning-off carbon microstructures 16. One example of tempering as discussed above is by way of heating with the second furnace 32 (FIG. 1). That is, the second furnace 32 may heat the workpiece 12 to between about 200° C. and about 400° C. to temper the first surface 14 when the hardness of the cast iron workpiece 12 is greater than about 600 Hv after selectively laser burning-off carbon microstructures 16. In another example, the second furnace 32 may heat the workpiece 12 to between about 250° C. and about 350° C., more preferably to about 300° C., to temper the first surface 14.

Moreover, the method 110 comprises in box 120 cooling the workpiece 12 to ambient temperature, defining the enhanced cast iron workpiece having increased lubricant retention. Furthermore, finish machining and/or honing of liners to a desired surface finish (e.g., mirror finish, cross-hatched finish) may be performed.

In one example, the method 110 further comprises preheating the workpiece 12 to between about 200° C. and about 400° C. to decrease risk of cracking. The step of preheating may be performed prior to the step of comprises selectively laser burning-off carbon microstructures 16 from the first surface 14. Preheating the workpiece 12 serves to lessen or prevent mass quenching after graphite burn-off. The step of preheating may be accomplished by way of the first furnace 30 discussed above.

Thus, prior to laser burn-off, the workpiece 12 may be placed in the first furnace 30 for preheating to between about 200° C. and about 400° C. to decrease risk of cracking after laser burn-off. Preferably, the workpiece 12 may be placed in the first furnace 30 for preheating to between about 250° C. and about 350° C., and more preferably to about 350° C. to decrease risk of cracking after laser burn-off. Moreover, preheating may improve throughput by reducing the laser exposure time required for graphite burn-off. Preheat may also reduce the risk of thin liners cracking during the laser graphite burn-off process.

It is to be noted that that geometry (thickness) of the workpiece or target material, desired oil retention characteristics (e.g., volume, depth, density, or quantity), and desired hardness will determine laser characteristics and parameters (e.g., spot size, intensity, energy, dithering, frequency). An example of laser parameters performed on a cast iron workpiece is provided below.

As an example, data below provides laser parameters that may be used for a cast iron workpiece detailed below. For a workpiece being grey cast iron grade 250, 250 MPa min (tensile strength), 207 to 255 HBW 10/3000 (hardness), 3.2 to 3.3% carbon, 5.0 max % ferrite, 1.0 max % carbides, Types B, D, E with minimum 50% of Type A (graphite flake type), and 4 to 6 (flake size), a laser tool with the following parameters may be used: YAG Solid State (Laser Type), 4 mm (laser spot size), 4800 W (power), 50 Hz (pattern frequency), 9000 mm/s (velocity of laser beam), and 1020° C. (temperature).

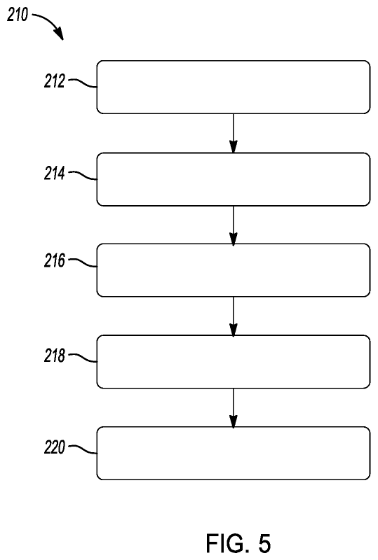

In accordance with another example of the present disclosure, FIG. 5 depicts a method 210 of making an enhanced cast iron workpiece having increased oil retention. In this example, the method 210 is implemented by the system 10 described above. However, any other suitable system may be used without departing from the spirit or scope of the present disclosure.

As shown, the method 210 comprises in box 212 providing a laser tool 20 arranged to emit a laser 22 to perform carbon burn-off from a cast iron workpiece 12. The cast iron workpiece 12 comprises cast iron and has a first surface 14 with carbon microstructures 16 thereon and within a subsurface thereof. In this example, the cast iron workpiece 12 may be a crankshaft, a cylinder having a bore, or any other suitable workpiece having carbon microstructures 16 formed thereon. In one embodiment, the laser tool 20 is arranged to emit a laser 22 having an output of between about 4000 W and about 9000 W. In another embodiment, the laser tool 20 is arranged to emit a laser 22 having an output of preferably about 4800 W.

The method 210 further comprises in box 214 cleaning the workpiece 12 to remove contamination thereon. The step of cleaning the workpiece 12 may be accomplished by an industrial washer and dried by air or by furnace. In one example, the industrial washer may be a water-based cleaner using relatively low and high pressure cleaning as known in the art.

As depicted in FIG. 5, the method 210 comprises in box 216 selectively laser burning-off carbon microstructures 16 from the first surface 14 of the workpiece 12 to form a pattern 24 on the first surface 14. Preferably, the laser 22 burns and vaporizes carbon microstructures 16, such as graphite, from the first surface 14 to form a customized area or pattern 24 on the first surface 14 and subsurface of the workpiece 12. In this embodiment, the pattern 24 has separate lubrication pockets, voids, or micro-pressure chambers 26 formed on the first surface 14 by the laser 22 where the carbon microstructures 16 were located and removed. Such pockets 26 on the first surface 14 may be used for lubricant or oil retention during tribilogical performance when an opposed body moves across the first surface 14 during operation. Upon laser burn-off and vaporization of the carbon microstructures 16, such patterns will not modify the entirety of the first surface 14 but rather modify only selected areas where carbon microstructures 16 were located thereon. Thus, a majority of the first surface 14 will serve as solid lubricants in the event of extreme tribological occurrence during operation of the workpiece 12.

Moreover, each separate pocket is separate from and free of fluid communication with any other pocket relative to the first surface 14, creating enhanced lubricant retention in each pocket of the first surface 14 during tribological performance of the workpiece 12. Moreover, each pocket 26 is free of any oil retention pathways and any interconnection with or between other pockets 26. That is, each pocket does not include a pathway interconnected with any other pocket 26.

Thus, each lubrication pocket 26 is separate from any other lubrication pocket 26 such that when an opposing body 28 moves across the first surface 14 during operation, lubricant migration is prevented (or lessened) between pockets 26, allowing lubricant 18 (e.g., oil) to be retained therein to facilitate improved oil retention. The enhanced lubricant retention defines a micro-pressurized chamber when an opposing body 28, e.g. a piston ring, movably slides across the first surface 14.

In this example, the method 210 further comprises in box 218 heating the workpiece 12 to between about 200° C. and about 400° C. to temper the first surface 14 when the hardness of the cast iron workpiece 12 is greater than about 600 Hv after the step of selectively laser burning-off carbon microstructures 16. After laser burn-off, tempering is preferably performed on the workpiece 12 to lessen case hardening. Tempering is preferably performed on the workpiece 12 when the hardness of the cast iron workpiece 12 is greater than about 600 Hv (Vickers hardness scale) after selectively laser burning-off carbon microstructures 16. One example of tempering as discussed above is by way of heating with the second furnace 32 (FIG. 1). That is, the second furnace 32 may heat the workpiece 12 to between about 200° C. and about 400° C. to temper the first surface 14 when the hardness of the cast iron workpiece 12 is greater than about 600 Hv after selectively laser burning-off carbon microstructures 16. In another example, the second furnace 32 may heat the workpiece 12 to between about 250° C. and about 350° C., and more preferably to about 300° C., to temper the first surface 14.

Moreover, the method 210 comprises in box 220 cooling the workpiece 12 to ambient temperature, defining the enhanced cast iron workpiece 12 having increased lubricant retention. Furthermore, finish machining and/or honing of liners to a desired surface finish (e.g., mirror finish, cross-hatched finish) may be performed.

In one example of this aspect, the method 210 further comprises preheating the workpiece 12 to between about 200° C. and about 400° C. to decrease risk of cracking. The step of preheating may be performed prior to the step of comprises selectively laser burning-off carbon microstructures 16 from the first surface 14. Preheating the workpiece 12 serves to lessen or prevent mass quenching after graphite burn-off. The step of preheating may be accomplished by way of the first furnace 30 discussed above.

Thus, prior to laser burn-off, the workpiece 12 may be placed in the first furnace 30 for preheating to between about 200° C. and about 400° C. to decrease risk of cracking after laser burn-off. Preferably, the workpiece 12 may be placed in the first furnace 30 for preheating to between about 250° C. and about 350° C., and more preferably to about 350° C. to decrease risk of cracking after laser burn-off. Moreover, preheating may improve throughput by reducing the laser exposure time required for graphite burn-off. Preheat may also reduce the risk of thin liners cracking during the laser graphite burn-off process.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of making an enhanced cast iron workpiece having increased oil retention, the method comprising:
providing a laser tool arranged to emit a laser to perform carbon burn-off from a cast iron workpiece, the cast iron workpiece comprising cast iron and having a first surface with carbon microstructures thereon;
cleaning the workpiece to remove contamination thereon;
selectively laser burning-off carbon microstructures from the first surface of the workpiece to form a pattern on the first surface, the pattern having separate pockets by the laser burn-off of carbon microstructures on the first surface, each separate pocket being separate from and free of fluid communication with any other pocket relative to the first surface, creating enhanced lubricant retention in each pocket on the first surface;
heating the workpiece to between about 200° C. and about 400° C. to temper the first surface;
cooling the workpiece to ambient temperature, defining the enhanced cast iron workpiece having increased lubricant retention.

2. The method of claim 1 further comprising preheating the workpiece to between about 200° C. and about 400° C. to decrease risk of cracking.

3. The method of claim 1 further comprising preheating the workpiece to between about 250° C. and about 350° C. to decrease risk of cracking.

4. The method of claim 1 further comprising preheating the workpiece to about 350° C. to decrease risk of cracking.

5. The method of claim 1 wherein the step of heating comprises heating the workpiece to between about 200° C. and about 400° C. to temper the first surface when the hardness of the cast iron workpiece is greater than about 600 Hv after the step of selectively laser burning-off carbon microstructure.

6. The method of claim 5 further including heating the workpiece to between about 250° C. and about 350° C. to temper the first surface.

7. The method of claim 6 further including heating the workpiece to between about 350° C. to temper the first surface.

8. The method of claim 1 wherein the step of laser burning-off includes a laser output of between about 4000 W and about 9000 W.

9. The method of claim 8 wherein laser output is about 4800 W.

10. The method of claim 1 wherein the carbon microstructures are graphite.

11. A system for making an enhanced cast iron workpiece having increased oil retention, the system comprising:
a cast iron workpiece comprising cast iron and having a first surface with carbon microstructures thereon;
a laser tool arranged to emit a laser on the cast iron workpiece to selectively laser burning-off carbon microstructures from the first surface of the cast iron workpiece forming a pattern on the first surface, the pattern having separate pockets formed on the first surface by the laser, each separate pocket being separate from and free of fluid communication with any other pocket relative to the first surface, creating enhanced lubricant retention in each pocket of the first surface;
a power source configured to power the laser tool; and
a controller configured to control the power to the laser tool to burn-off carbon microstructures from the first surface of the cast iron workpiece.

12. The system of claim 11 further comprising a first furnace for preheating the workpiece to between about 200° C. and about 400° C. to decrease risk of cracking.

13. The system of claim 11 further comprising a first furnace for preheating the workpiece to between about 250° C. and about 350° C. to decrease risk of cracking.

14. The system of claim 11 further comprising a first furnace for preheating the workpiece to about 350° C. to decrease risk of cracking.

15. The system of claim 11 further comprising a second furnace for heating the workpiece to between about 200° C. and about 400° C. to temper the first surface when the hardness of the cast iron workpiece is greater than about 600 Hv after the step of selectively laser burning-off carbon microstructure.

16. The system of claim 11 further comprising a second furnace for heating the workpiece to between about 250° C. and about 350° C. to temper the first surface when the hardness of the cast iron workpiece is greater than about 600 Hv after the step of selectively laser burning-off carbon microstructure.

17. The system of claim 11 further comprising a second furnace for heating the workpiece to about 350° C. to temper the first surface when the hardness of the cast iron workpiece is greater than about 600 Hv after the step of selectively laser burning-off carbon microstructure.

18. The system of claim 11 wherein the laser tool is arranged to emit a laser having an output of between about 4000 W and about 9000 W.

19. The system of claim 18 wherein laser output is about 4800 W.

20. A method of making an enhanced cast iron workpiece having increased oil retention, the method comprising:
providing a laser tool arranged to emit a laser to perform carbon burn-off from a cast iron workpiece, the cast iron workpiece comprising cast iron and having a first surface with carbon microstructures thereon;
cleaning the workpiece to remove contamination thereon;
selectively laser burning-off carbon microstructures from the first surface of the workpiece to form a pattern on the first surface, the pattern having separate pockets by the laser burn-off of carbon microstructures on the first surface, each separate pocket being separate from and free of fluid communication with any other pocket relative to the first surface, creating enhanced lubricant retention in each pocket on the first surface;
heating the workpiece to between about 200° C. and about 400° C. to temper the first surface when the hardness of the cast iron workpiece is greater than about 600 Hv after the step of selectively laser burning-off carbon microstructure; and
cooling the workpiece to ambient temperature, defining the enhanced cast iron workpiece having increased lubricant retention.
